(19) United States
(12) Patent Application Publication
(10) Pub. No.: US 2011/0013424 A1
(43) Pub. Date: Jan. 20, 2011

(54) FORWARD CONVERTER WITH SECONDARY SIDE POST-REGULATION AND ZERO VOLTAGE SWITCHING

(75) Inventors: Chih-Liang WANG, Keelung City (TW); Ching-Sheng YU, Taipei County (TW)

Correspondence Address: Muncy, Geissler, Olds & Lowe, PLLC, 4000 Legato Road, Suite 310, FAIRFAX, VA, 22033, US

(73) Assignees: Chih-Liang WANG, Keelung City (TW); GlacialTech., Inc., Jhonghe City (TW)

(21) Appl. No.: 12/835,160

(22) Filed: Jul. 13, 2010

(30) Foreign Application Priority Data
Jul. 14, 2009 (TW) 098123743

(51) Int. Cl. H02M 3/335

(52) U.S. Cl. 363/21.06

(57) ABSTRACT

The present invention discloses a forward converter with secondary side post-regulation and zero voltage switching, where the primary side power loop may adopt a single or a dual transistor structure, driven by a primary side driving circuit with a constant duty ratio so that the voltage waveform across the secondary side power winding has a constant pulse width; the secondary side power loop uses a controllable switch, a magnetic amplifier (MA) or an N channel metal oxide semiconductor field transistor (NMOS), to blank the leading edge of the voltage waveform across the secondary side power winding, regulate the output voltage, and achieve zero voltage switching of primary side switch transistors.

### FIELD OF THE INVENTION

The present invention generally relates to a forward converter, and more particularly to a forward converter with secondary side post-regulation and zero voltage switching, achieving zero voltage switching of primary side switch transistors while post-regulating the output voltage at the secondary side.

### DESCRIPTION OF THE RELATED ART

FIGS. 1 and 2 respectively depict conventional main frames of a single and a dual transistor forward converter having primary side pre-regulation and self-driven synchronous rectifiers, wherein a secondary side error amplification circuit not shown therein detects a sample of an output voltage and compares the sample voltage with a reference voltage to generate an error signal optically coupled to a primary side control circuit and converted into Pulse Width Modulation (PWM) driving signals of primary side switch transistors for regulating the output voltage.

If the conventional forward converter operates in Continuous Conduction Mode (CCM), the output voltage Vₒᵤₜ is expressible as

$${V}_{out} = \frac{{N}_{s}}{{N}_{p}} {D}_{pri} {V}_{in} ,$$

wherein Vᵢₙ is the input voltage, Dₚᵣᵢ is the variable primary duty ratio of primary side switch transistors, Nₚ is the turns number of the primary side power winding, and Nₛ is the turns number of the secondary side power winding. When Vₒᵤₜ is lower than its predetermined value, Dₚᵣᵢ is increased to appreciate Vₒᵤₜ; when Vₒᵤₜ is higher than its predetermined value, Dₚᵣᵢ is decreased to depreciate Vₒᵤₜ. Consequently, modulating Dₚᵣᵢ can straightforwardly regulate Vₒᵤₜ. Although very facile, the abovementioned primary side pre-regulation can not achieve zero-voltage switching of primary side switch transistors and suffers from higher switching losses.

Both the transformer T₁ in FIG. 1 and the transformer T₂ in FIG. 2 include a primary side power winding Nₚ connecting to a primary side power loop, a secondary side power winding Nₛ connecting to a secondary side power loop, and a secondary side driving winding N_{d} inducing driving signals of secondary side self-driven synchronous rectifiers. Since Nₚ itself in FIG. 1 is inapplicable to reset the core of T₁ but Nₚ itself in FIG. 2 is applicable to reset the core of T₂, the single transistor structure needs a primary side reset winding Nᵣ but the dual transistor structure needs no primary side reset winding Nᵣ. In general, the turns number of Nᵣ may be fewer than, equal to, or more than that of Nₚ, respectively causing the maximum drain-source voltage of the primary side switch transistor in the single transistor structure to be higher than, equal to, or lower than 2Vᵢₙ. In contrast, the maximum drain-source voltage of primary side switch transistors in the dual transistor structure identically equals Vᵢₙ. The black dots juxtaposed on certain winding terminals indicate reference polarities for various winding voltages. The dotted and the un-dotted terminal are respectively defined as the positive and the negative terminal of the reference polarity. If the actual polarity coincides with the reference polarity, the winding voltage is positive. Otherwise, it is negative. Because an actual transformer must draw a magnetization current from an external circuit to build up a flux linkage in its core magnetic circuit for inducing various winding voltages, such an electromagnetic conversion process can be electrically modeled as a suppositional magnetization inductor Lₘ in parallel with the primary side power winding Nₚ. The increasing of the magnetization current represents the magnetization of the transformer core magnetic circuit, and the decreasing of the magnetization current represents the demagnetization of the transformer core magnetic circuit.

The primary side power loop in FIG. 1 comprises an input voltage terminal Vᵢ, a primary ground terminal Vᵣᵢ, an input filter capacitor Cᵢ having a positive and a negative terminal, a primary side reset winding Nᵣ, a reset diode D₁ having an anode and a cathode, a parallel connection of a suppositional magnetization inductor Lₘ and a primary side power winding Nₚ, as well as a N channel Metal Oxide Semiconductor Field Effect Transistor (NMOSFET) Q₁ having a gate, a drain, a source, and a drain-source capacitor C₁. Herein, both Vᵢ and Vᵣᵢ connect to an external DC input voltage source Vᵢₙ; a positive and a negative terminal of Cᵢ respectively connect to Vᵢ and Vᵣᵢ; the un-dotted and the dotted terminal of Nᵣ respectively connect to Vᵢ and the cathode of D₁; the anode of D₁ connects to Vᵣᵢ; the dotted and the un-dotted terminal of Nₚ respectively connect to Vᵢ and the drain of Q₁; the source of a connects to Vᵣᵢ; the gate of Q₁ connects to the primary side PWM driving circuit not shown therein; as well as Lₘ and C₁ can constitute a series resonance circuit.

The primary side power loop in FIG. 2 comprises an input voltage terminal Vᵢ, a primary ground terminal Vᵣᵢ, an input filter capacitor Cᵢ having a positive and a negative terminal, a first D₁ and a second reset diode D₂ both having an anode and a cathode, a parallel connection of a suppositional magnetization inductor Lₘ and a primary side power winding Nₚ, as well as a first Q₁ and a second NMOSFET Q₂ both having a gate, a drain, a source, and a drain-source capacitor C₁=C₂. Herein, both Vᵢ and Vᵣᵢ connect to an external DC input voltage source Vᵢₙ; a positive and a negative terminal of Cᵢ respectively connect to Vᵢ and Vᵣᵢ; a cathode and an anode of D₁ respectively connect to the source of Q₁ and Vᵣᵢ; a cathode and an anode of D₂ respectively connect to Vᵢ and the drain of Q₂; the drain of Q₁ connects to Vᵢ; the dotted and the un-dotted terminal of Nₚ respectively connect to the source of Q₁ and the drain of Q₂; the source of Q₂ connects to Vᵣᵢ; the gates of Q₁ and Q₂ both connect to the primary side PWM driving circuit not shown therein; as well as Lₘ, C₁, and C₂ can constitute a series resonance circuit.

Each of the secondary side power loops in FIGS. 1 and 2 comprises a secondary side driving winding N_{d}, a secondary side power winding Nₛ, a forward SR_{f} and a freewheeling synchronous rectifier SR_{w} both having a gate, a drain, and a source, a forward gate resistor R₁, a forward gate-source resistor R₂, a freewheeling gate-source resistor R₃, a freewheeling gate resistor R₄ all having a first and a second terminal, an output power inductor Lₒ having a first and a second terminal, an output filter capacitor Cₒ having a positive and a negative terminal, an output voltage terminal Vₒ, as well as a secondary ground terminal Vᵣₒ. Herein, the dotted and the un-dotted terminal of N_{d} respectively connect to the first terminal of R₁ and the first terminal of R₄; the second terminal of R₁ and the second terminal of R₄ respectively connect to the gate of SR_{f} and the gate of SR_{w}; the first and the second terminal of R₂ respectively connect to the gate and the source of SR_{f}; the first and the second terminal of R₃ respectively connect to the gate and the source of SR_{w}; the dotted and the un-dotted terminal of Nₛ respectively connect to the drain of SR_{w} and the drain of SR_{f}; the sources of SR_{f} and SR_{w} both connect to Vᵣₒ; the first and the second terminal of Lₒ respectively connect to the drain of SR_{w} and Vₒ; the positive and the negative terminal of Cₒ respectively connect to Vₒ and Vᵣₒ; the increasing of the output power inductor current represents the storing of energy to the inductor core magnetic circuit, and the decreasing of the output power inductor current represents the releasing of energy from the inductor core magnetic circuit.

The operating principle of the single transistor structure can be easily inferred from that of the dual transistor structure, thus only the latter is explicitly described hereinafter. FIG. 3 depicts crucial waveforms of FIG. 2 during a switching period, wherein vₚ^{GS}(t) and vₚ^{DS}(t) are respectively the gate-source voltage and the drain-source voltage, referring to different source potential, of Q₁ and Q₂; v_{L}_{ₘ}(t) is the voltage across Lₘ; i_{L}_{ₘ}(t) is the current through Lₘ; v_{f}^{GS}(t) and v_{w}^{GS}(t) are respectively the gate-source voltages, referring to same source potentials, of SR_{f} and SR_{w}; i_{L}_{ₒ}(t) is the current through Lₒ; Vᵢₙ is the input voltage; Vₒᵤₜ is the output voltage; Iₒᵤₜ is the output current; as well as

$$n = \frac{{N}_{p}}{{N}_{s}}$$

is the turns ratio of the primary to the secondary side power winding.

During the interval of t₀≦t<t₁, vₚ^{GS}(t) is high; the channels of Q₁ and Q₂ are both on; vₚ^{DS}(t)=0; both D₁ and D₂ are off due to reverse biases; v_{L}_{ₘ}(t)=Vᵢₙ−2vₚ^{DS}(t)=Vᵢₙ; Lₘ is clamped to Vᵢₙ and magnetized by i_{L}_{ₘ}(t) flowing through the channel of Q₂, Cᵢ, and the channel of Q₁; i_{L}_{ₘ}(t) is increasing linearly with a positive slope

$$\frac{d {i}_{{L}_{m}} ( t )}{d t} = \frac{{V}_{in}}{{L}_{m}} ;$$

the induced voltage across N_{d} makes v_{f}^{GS}(t)>0 and v_{w}^{GS}(t)<0 the channel of SR_{f} is on and the channel of SR_{w} is off; i_{L}_{ₒ}(t) flows through Cₒ, the channel of SR_{f}, and Nₛ to magnetize Lₒ; as well as i_{L}_{ₒ}(t) is increasing linearly with a positive slope

$$\frac{d {i}_{{L}_{o}} ( t )}{d t} = \frac{1}{{L}_{o}} ( \frac{{V}_{in}}{n} - {V}_{out} ) .$$

During the interval of t₁≦t<t₂, vₚ^{GS}(t) is low; the channels of Q₁ and Q₂ are both off;

$$0 \leq {v}_{p}^{DS} ( t ) < \frac{{V}_{in}}{2} ;$$

both D₁ and D₂ are off due to reverse biases; v_{L}_{ₘ}(t)=Vᵢₙ−2vₚ^{DS}(t)>0; Lₘ is magnetized by i_{L}_{ₘ}(t) flowing through C₂, Cᵢ, and C₁; the induced voltage across N_{d} makes v_{f}^{GS}(t)>0 and v_{w}^{GS}(t)<0; the channel of SR_{f} is on and the channel of SR_{w} is off; i_{L}_{ₒ}(t) flows through Cₒ, the channel of SR_{f}, and Nₛ to magnetize Lₒ; both C₁ and C₂ are charged by a reflected output current

$$\frac{{I}_{out}}{n} ;$$

as well as vₚ^{DS}(t) is increasing linearly with a positive slope

$$\frac{d {v}_{p}^{DS} ( t )}{d t} = \frac{{I}_{out}}{{nC}_{1}} .$$

During the interval of t₂≦t<t₃, vₚ^{GS}(t) is low; the channels of Q₁ and Q₂ are both off;

$$\frac{{V}_{in}}{2} \leq {v}_{p}^{DS} ( t ) < {V}_{in} ;$$

both D₁ and D₂ are off due to reverse biases; v_{Lm}(t)=Vᵢₙ−2vₚ^{DS}(t)<0; Lₘ is demagnetized by i_{L}_{ₘ}(t) flowing through C₂, Cᵢ, and C₁; the induced voltage across N_{d} makes v_{f}^{GS}(t)<0 and v_{w}^{GS}(t)>0; the channel of SR_{f} is off and the channel of SR_{w} is on; i_{L}_{ₒ}(t) flows through Cₒ and the channel of SR_{w} to demagnetize Lₒ; i_{L}_{ₒ}(t) is decreasing linearly with a negative slope

$$\frac{d {i}_{{L}_{o}} ( t )}{d t} = - \frac{{V}_{out}}{{L}_{o}} ; {N}_{p}$$

resembles an open circuit conducting no reflected output current; as well as Lₘ, C₁, and C₂ constitute a series resonance circuit to increase vₚ^{DS}(t) and slightly decrease i_{L}_{ₘ}(t).

During the interval of t₃≦t<t₄, vₚ^{GS}(t) is low; the channels of Q₁ and Q₂ are both off; vₚ^{DS}(t)=Vᵢₙ; both D₁ and D₂ are on due to forward biases; v_{L}_{ₘ}(t)=Vᵢₙ−2vₚ^{DS}(t)=−Vᵢₙ; Lₘ is clamped to −Vᵢₙ and demagnetized by i_{L}_{ₘ}(t) flowing through D₂, Cᵢ, and D₁; i_{L}_{ₘ}(t) is decreasing linearly with a negative slope

$$\frac{d {i}_{{L}_{m}} ( t )}{d t} = - \frac{{V}_{in}}{{L}_{m}} ;$$

the induced voltage across N_{d} makes v_{f}^{GS}(t)<0 and v_{w}^{GS}(t)>0; the channel of SR_{f} is off and the channel of SR_{w} is on; i_{L}_{ₒ}(t) flows through Cₒ and the channel of SR_{w} to demagnetize Lₒ; as well as i_{L}_{ₒ}(t) is decreasing linearly with a negative slope

$$\frac{d {i}_{{L}_{o}} ( t )}{d t} = - \frac{{V}_{out}}{{L}_{o}} .$$

During the interval of t₄≦t<t₅, vₚ^{GS}(t) is low; the channels of Q₁ and Q₂ are both off;

$$\frac{{V}_{in}}{2} < {v}_{p}^{DS} ( t ) \leq {V}_{in} ;$$

both D₁ and D₂ are off due to reverse biases; v_{L}_{ₘ}(t)=Vᵢₙ−2vₚ^{DS}(t)<0; Lₘ has been demagnetized completely; i_{L}_{ₘ}(t)≈0; the induced voltage across N_{d} makes v_{f}^{GS}(t)<0 and v_{w}^{GS}(t)>0; the channel of SR_{f} is off and the channel of SR_{w} is on; i_{L}_{ₒ}(t) flows through Cₒ and the channel of SR_{w} to demagnetize Lₒ; i_{L}_{ₒ}(t) is decreasing linearly with a negative slope

$$\frac{d {i}_{{L}_{o}} ( t )}{d t} = - \frac{{V}_{out}}{{L}_{o}} ; {N}_{p}$$

resembles an open circuit conducting no reflected output current; as well as Lₘ, C₁, and C₂ constitute a series resonance circuit to decrease vₚ^{DS}(t) and slightly increase i_{L}_{ₘ}(t).

During the interval of t₅≦t<t₀, vₚ^{GS}(t) is low; the channels of Q₁ and Q₂ are both off;

$${v}_{p}^{DS} ( t ) = \frac{{V}_{in}}{2} ;$$

both D₁ and D₂ are off due to reverse biases; v_{L}_{ₘ}(t)=Vᵢₙ−2vₚ^{DS}(t)=0; Lₘ has been demagnetized completely; i_{L}_{ₘ}(t)≈0; the induced voltage across N_{d} makes v_{f}^{GS}(t)=0 and v_{w}^{GS}(t)=0; the channels of SR_{f} and SR_{w} are both off; the continuous inductor current i_{L}_{ₒ}(t) forces the body diodes of SR_{f} and SR_{w} to turn on; i_{L}_{ₒ}(t) flows through Cₒ and (1) the body diode of SR_{f} and Nₛ or (2) the body diode of SR_{w} to demagnetize Lₒ; i_{L}_{ₒ}(t) is decreasing linearly with a negative slope

$$\frac{d {i}_{{L}_{o}} ( t )}{d t} = - \frac{{V}_{out}}{{L}_{o}} ;$$

as well as v_{L}_{ₘ}(t) is clamped to 0 and vₚ^{DS}(t) is clamped to

$$\frac{{V}_{in}}{2}$$

because the body diodes of SR_{f} and SR_{w} are both turned on.

Since

$${v}_{p}^{DS} ( {t}_{{0}^{′}}^{-} ) = \frac{{V}_{in}}{2}$$

is a higher positive voltage as well as both Q₁ and Q₂ are switched on again at t=t_{0·}to discharge vₚ^{DS}(t_{0·})=0, the conventional forward converters with primary side pre-regulation can not achieve the zero voltage switching of the primary side switch transistors and suffer from higher switching losses.

### SUMMARY OF THE INVENTION

The present invention is directed to a forward converter with secondary side post-regulation and zero voltage switching, wherein a primary side power loop may be but not confined to a single or a dual transistor structure having primary side switch transistors driven by a primary side driving circuit with a constant duty ratio so as to make the voltage waveform across the secondary side power winding have a fixed pulse width; the secondary side power loop uses a controllable switch, which may be but not confined to a Magnetic Amplifier (MA) or a NMOSFET, to blank the leading edge of the voltage waveform across the secondary side power winding; post-regulate the output voltage; and achieve zero voltage switching of primary side switch transistors.

The secondary side power loop comprises a secondary side driving winding, a secondary side power winding, a forward and a freewheeling synchronous rectifier both having a gate, a drain, and a source, a controllable switch having a control, a first channel, and a second channel terminal, a forward gate resistor, a forward gate-source resistor, a freewheeling gate-source resistor and a freewheeling gate resistor both depending on the topology, an output power inductor having a first and a second terminal, an output filter capacitor having a positive and a negative terminal, an output voltage terminal, as well as a secondary ground terminal. Herein, the dotted and the un-dotted terminal of the secondary side power winding respectively connect to the first channel terminal of the controllable switch and the drain of the forward synchronous rectifier; the second channel terminal of the controllable switch connects to the drain of the freewheeling synchronous rectifier; the sources of the forward and the freewheeling synchronous rectifier both connect to the secondary ground terminal; the first and the second terminal of the output power inductor respectively connect to the drain of the freewheeling synchronous rectifier and the output voltage terminal; as well as the positive and the negative terminal of the output filter capacitor respectively connect to the output voltage and the secondary ground terminal.

The forward synchronous rectifier is driven by the secondary side driving winding;

the controllable switch is driven by the secondary side PWM control circuit. The freewheeling synchronous rectifier may be driven by the secondary side PWM control circuit or the secondary side driving winding. If the freewheeling synchronous rectifier is driven by the secondary side PWM control circuit, the dotted terminal of the secondary side driving winding connects to the gate of the forward synchronous rectifier through the forward gate resistor; the un-dotted terminal of the secondary side driving winding connects to the secondary ground terminal; as well as the forward gate-source resistor connects to the gate and the source of the forward synchronous rectifier. If the freewheeling synchronous rectifier is driven by the secondary side driving winding, the dotted terminal of the secondary side driving winding connects to the gate of the forward synchronous rectifier through the forward gate resistor; the un-dotted terminal of the secondary side driving winding connects to the gate of the freewheeling synchronous rectifier through the freewheeling gate resistor, the forward gate-source resistor connects to the gate and the source of the forward synchronous rectifier, as well as the freewheeling gate-source resistor connects to the gate and the source of the freewheeling synchronous rectifier.

### BRIEF DESCRIPTION OF THE DRAWINGS

FIGS. 1 and 2 respectively depict conventional main frames of a single and a dual transistor forward converter.

FIG. 3 depicts crucial waveforms of FIG. 2 during a switching period.

FIGS. 4 and 5 respectively depict main frames of a first and a second embodiment based on the present invention.

FIG. 6 depicts crucial waveforms of FIG. 5 during a switching period.

FIGS. 7 and 8 respectively depict main frames of a third and a fourth embodiment based on the present invention.

FIG. 9 depicts crucial waveforms of FIG. 8 during a switching period.

### DETAILED DESCRIPTION OF THE INVENTION

The advantages, features, objectives, and technologies of the present invention will become more apparent from the following description in conjunction with the accompanying drawings, wherein certain embodiments of the present invention are set forth by way of illustration and examples.

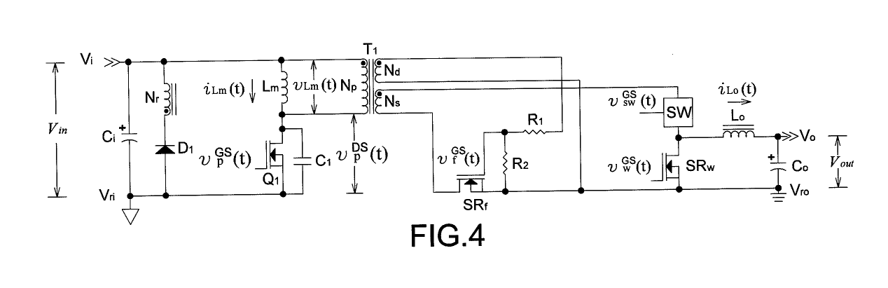

FIGS. 4, 5, 7, and 8 respectively depict main frames of a first, a second, a third and, a fourth embodiment based on the present invention. A secondary side error amplification circuit not shown therein detects a sample of the output voltage and compares the sample voltage with a reference voltage to generate an error signal fed back to a secondary side PWM control circuit not shown therein and converted into a PWM driving signal of a secondary side controllable switch for regulating the output voltage.

If D*ₚᵣᵢ is a constant primary duty ratio of primary side switch transistors, the output voltage Vₒᵤₜ is expressible as

$${V}_{out} = \frac{{N}_{s}}{{N}_{p}} {D}_{sec} {V}_{in} ,$$

wherein Vᵢₙ is the input voltage; Nₚ is the turns number of the primary side power winding; Nₛ is the turns number of the secondary side power winding; and D_{sec}≦D*ₚᵣᵢ is a variable secondary duty ratio of a secondary side controllable switch. A variable leading edge blanking time T_{blank} is expressible as T_{blank}=(D*ₚᵣᵢ−D_{sec})Tₛ, wherein Tₛ is a switching period. When Vₒᵤₜ is lower than its predetermined value, D_{sec} is increased or T_{blank} is decreased to appreciate Vₒᵤₜ; when Vₒᵤₜ is higher than its predetermined value, D_{sec} is decreased or T_{blank} is increased to depreciate Vₒᵤₜ. Hence, it can regulate Vₒᵤₜ to modulate D_{sec} or T_{blank}. Besides, the abovementioned secondary side post-regulation can also achieve zero voltage switching of primary side switch transistors to further reduce switching losses.

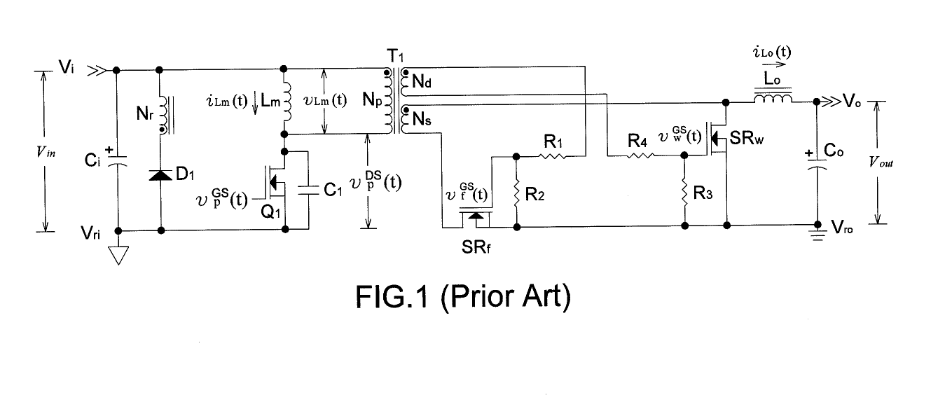

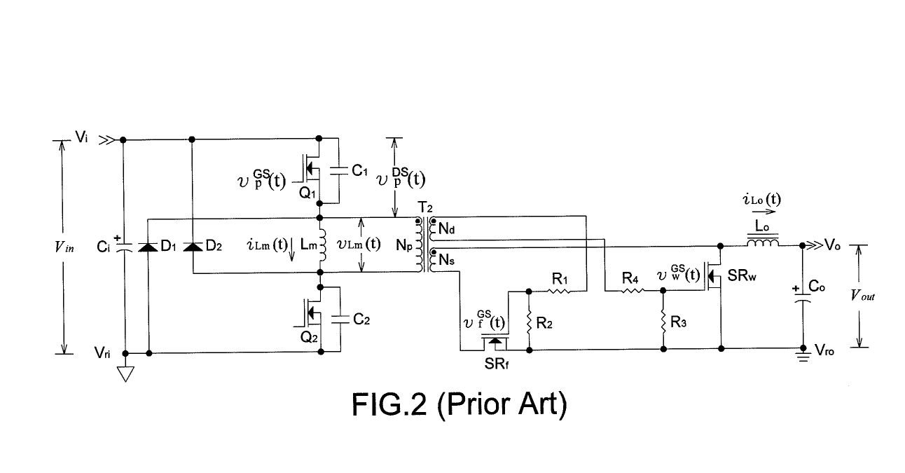

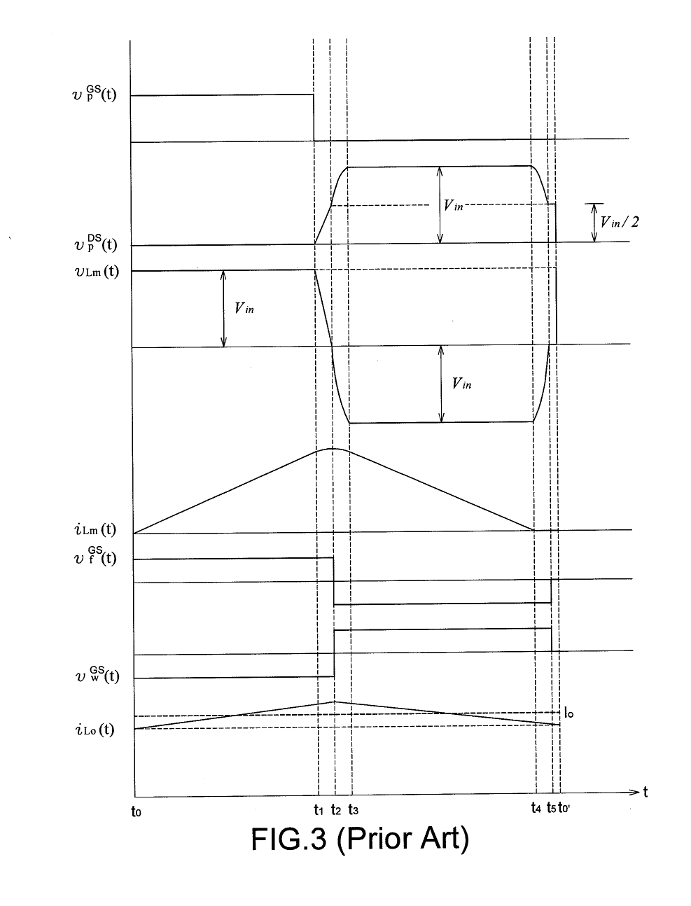

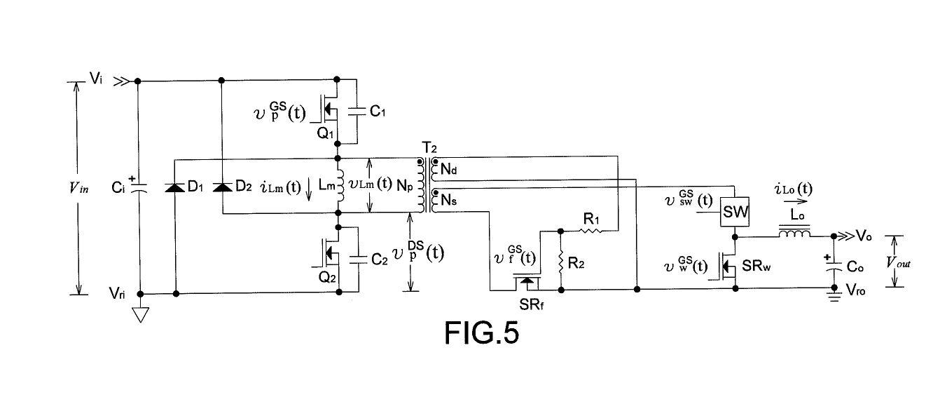

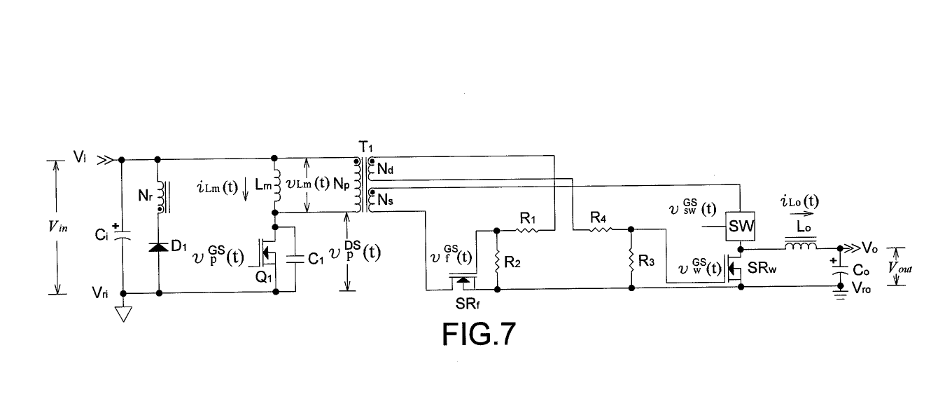

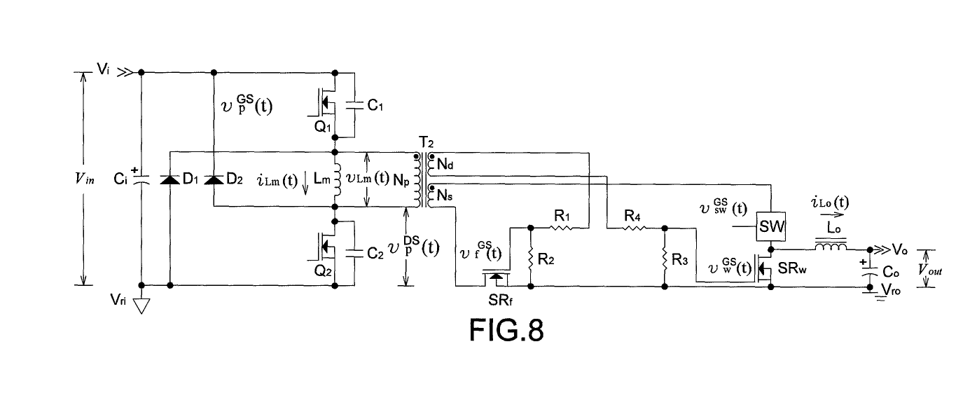

Because primary side power loops in FIGS. 4 and 7 as well as in FIGS. 5 and 8 are respectively identical to those in FIG. 1 and in FIG. 2, their structural characteristics will not be reiterated in what follows. However, here are some of the remarkable differences between prior arts and the present invention. Distinguishable from the primary side switch transistors in FIGS. 1 and 2 driven with a variable duty ratio, those in FIGS. 4, 5, 7, and 8 are driven with a constant duty ratio. In prior arts, the error signal generated from comparing the sample voltage with a reference voltage is optically coupled to a primary side PWM control circuit needing an optocoupler circuit. In the present invention, it is fed back to a secondary side PWM control circuit needing no optocoupler circuit.

Each of secondary side power loops in FIGS. 4, 5, 7, and 8 comprises a secondary side driving winding N_{d}, a secondary side power winding Nₛ, a forward SR_{f} and a freewheeling synchronous rectifier SR_{w} both having a gate, a drain, and a source, a controllable switch SW having a control, a first channel, and a second channel terminal, a forward gate resistor R₁, a forward gate-source resistor R₂, a freewheeling gate-source resistor R₃ and a freewheeling gate resistor R₄ depending on the topology, an output power inductor Lₒ having a first and a second terminal, an output filter capacitor Cₒ having a positive and a negative terminal, an output voltage terminal Vₒ, as well as a secondary ground terminal Vᵣₒ. Herein, the dotted and the un-dotted terminal of Nₛ respectively connect to the first channel terminal of SW and the drain of SR_{f}; the second channel terminal of SW connects to the drain of SR_{w}; the sources of SR_{f} and SR_{w} both connect to Vᵣₒ; a first and a second terminal of Lₒ respectively connect to the drain of SR_{w} and Vₒ; as well as a positive and a negative terminal of Cₒ respectively connect to Vₒ and Vᵣₒ.

SR_{f} is driven by N_{d}; SW is driven by the secondary side PWM control circuit. SR_{w} may be driven by the secondary side PWM control circuit, a topology depicted in FIGS. 4 and 5, or by N_{d}, a topology depicted in FIGS. 7 and 8. If SR_{w} is driven by the secondary side PWM control circuit, the dotted terminal of N_{d} connects to the gate of SR_{f} through R₁, the un-dotted terminal of N_{d} connects to Vᵣₒ, as well as R₂ connects to the gate and the source of SR_{f}. If SR_{w} is driven by N_{d}, the dotted terminal of N_{d} connects to the gate of SR_{f} through R₁, the un-dotted terminal of N_{d} connects to the gate of SR_{w} through R₄, as well as R₂ and R₃ respectively connect to the gate and the source of SR_{f} and SR_{w}.

In general, SW can be embodied with a MA or a NMOSFET. For the convenience of description, SW is assumed an NMOSFET with a gate, a drain, and a source respectively corresponding to the control, the first channel, and the second terminal. Being the counterpart of the description for embodiments with a NMOSFET, the description for embodiments with a MA can be omitted without loss of generality.

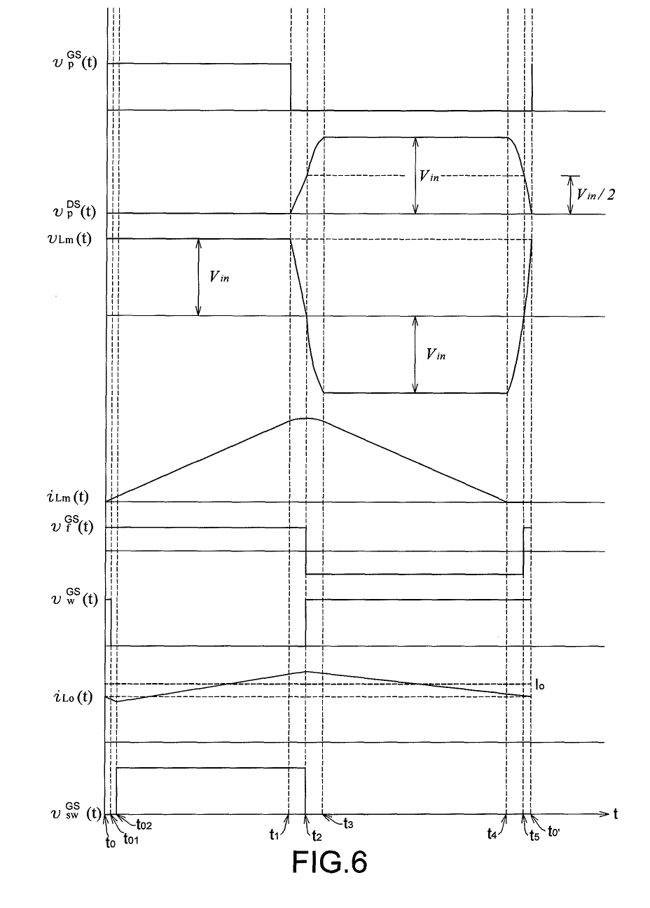

FIG. 6 depicts crucial waveforms of FIG. 5 during a switching period, wherein SR_{w} is driven by the secondary side PWM control circuit.

During the interval of t₀≦t<t₁, vₚ^{GS}(t) is high; the channels of Q₁ and Q₂ are both on; vₚ^{DS}(t)=0; both D₁ and D₂ are off due to reverse biases; v_{L}_{ₘ}(t)=Vᵢₙ−2vₚ^{DS}(t)=Vᵢₙ; Lₘ is clamped to Vᵢₙ and magnetized by i_{L}_{ₘ}(t) flowing through the channel of Q₂, Cᵢ, and the channel of Q₁; i_{L}_{ₘ}(t) is increasing linearly with a positive slope

$$\frac{d {i}_{{L}_{m}} ( t )}{d t} = \frac{{V}_{in}}{{L}_{m}} ;$$

the induced voltage across N_{d} makes v_{f}^{GS}(t)>0; the channel of SR_{f} is on. According to v_{sw}^{GS}(t) and v_{w}^{GS}(t) provided by the secondary side PWM control circuit, this interval can be further subdivided into three subintervals:
During the subinterval of t₀≦t<t₀₁, SW switches off its channel to blank the leading edge of the voltage waveform across Nₛ; SR_{w} switches on its channel to reduce the conduction loss of its body diode; i_{L}_{ₒ}(t) flows through Cₒ and the channel of SR_{w} to demagnetize Lₒ; as well as i_{L}_{ₒ}(t) is decreasing linearly with a negative slope

$$\frac{d {i}_{{L}_{o}} ( t )}{d t} = - \frac{{V}_{out}}{{L}_{o}} .$$

During the subinterval of t₀₁≦t<t₀₂, SW switches off its channel to blank the leading edge of the voltage waveform across Nₛ; SR_{w} switches off its channel to avoid a cross conduction between SW and SR_{w} at t=t₀₂; (t) flows through Cₒ and the body diode of SR_{w} to demagnetize Lₒ; as well as i_{L}_{ₒ}(t) is decreasing linearly with a negative slope

$$\frac{d {i}_{{L}_{o}} ( t )}{d t} = - \frac{{V}_{out}}{{L}_{o}} .$$

During the subinterval of t₀₂≦t<t₁, SW switches on its channel and SR_{w} switches off its channel; i_{L}_{ₒ}(t) flows through Cₒ, the channel of SR_{f}, Nₛ, and the channel of SW to magnetize Lₒ; as well as i_{L}_{ₒ}(t) is increasing linearly with a positive slope

$$\frac{d {i}_{{L}_{o}} ( t )}{d t} = \frac{1}{{L}_{o}} ( \frac{{V}_{in}}{n} - {V}_{out} ) .$$

As depicted in FIG. 6, the variable leading edge blanking time T_{blank} is also expressible as T_{blank}=t₀₂−t₀ and modulated via t₀₂ to regulate the output voltage Vₒᵤₜ.

During the interval of t₁≦t<t₂, vₚ^{GS}(t) is low; the channels of Q₁ and Q₂ are both off;

$$0 \leq {v}_{p}^{DS} ( t ) < \frac{{V}_{in}}{2} ;$$

both D₁ and D₂ are off due to reverse biases; v_{L}_{ₘ}(t)=Vᵢₙ−2vₚ^{DS}(t)>0; Lₘ is magnetized by i_{L}_{ₘ}(t) flowing through C₂, Cᵢ, and C₁; the induced voltage across N_{d} makes v_{f}^{GS}(t)>0; the channel of SR_{f} is on; the secondary side PWM control circuit switches on the channel of SW and switches off the channel of SR_{w}; i_{L}_{ₒ}(t) flows through Cₒ, the channel of SR_{f}, Nₛ, and the channel of SW to magnetize Lₒ; both C₁ and C₂ are charged by a reflected output current

$$\frac{{I}_{out}}{n} ;$$

and vₚ^{DS}(t) is increasing linearly with a positive slope

$$\frac{d {v}_{p}^{DS} ( t )}{d t} = \frac{{I}_{out}}{{nC}_{1}} .$$

During the interval of t₂≦t<t₃, vₚ^{GS}(t) is low; the channels of Q₁ and Q₂ are both off;

$$\frac{{V}_{in}}{2} \leq {v}_{p}^{DS} ( t ) < {V}_{in} ;$$

both D₁ and D₂ are off due to reverse biases; v_{Lm}(t)=Vᵢₙ2vₚ^{DS}(t)<0; Lₘ is demagnetized by i_{L}_{ₘ}(t) flowing through C₂, Cᵢ, and C₁; the induced voltage across N_{d} makes v_{f}^{GS}(t)<0; the channel of SR_{f} is off; Nₚ resembles an open circuit conducting no reflected output current; Lₘ, C₁, and C₂ constitute a series resonance circuit to increase vₚ^{DS}(t) and slightly decrease i_{L}_{ₘ}(t); the secondary side PWM control circuit switches off the channel of SW and switches on the channel of SR_{w}; i_{L}_{ₒ}(t) flows through Cₒ and the channel of SR_{w} to demagnetize Lₒ; as well as i_{L}_{ₒ}(t) is decreasing linearly with a negative slope

$$\frac{d {i}_{{L}_{o}} ( t )}{d t} = - \frac{{V}_{out}}{{L}_{o}} .$$

During the interval of t₃≦t<t₄, vₚ^{GS}(t) is low; the channels of Q₁ and Q₂ are both off; vₚ^{DS}(t)=Vᵢₙ; both D₁ and D₂ are on due to forward biases; v_{L}_{ₘ}(t)=Vᵢₙ−2vₚ^{DS}(t)=−Vᵢₙ; Lₘ is clamped to −Vᵢₙ and demagnetized by i_{L}_{ₘ}(t) flowing through D₂, Cᵢ, and D₁; i_{L}_{ₘ}(t) is decreasing linearly with a negative slope

$$\frac{d {i}_{{L}_{m}} ( t )}{d t} = - \frac{{V}_{in}}{{L}_{m}} ;$$

the induced voltage across N_{d} makes v_{f}^{GS}(t)<0; the channel of SR_{f} is off; the secondary side PWM control circuit switches off the channel of SW and switches on the channel of SR_{w}; i_{L}_{ₒ}(t) flows through Cₒ and the channel of SR_{w} to demagnetize Lₒ; as well as i_{L}_{ₒ}(t) is decreasing linearly with a negative slope

$$\frac{d {i}_{{L}_{o}} ( t )}{d t} = - \frac{{V}_{out}}{{L}_{o}} .$$

During the interval of t₄≦t<t₅, vₚ^{GS}(t) is low; the channels of Q₁ and Q₂ are both off;

$$\frac{{V}_{in}}{2} < {v}_{p}^{DS} ( t ) \leq {V}_{in} ;$$

both D₁ and D₂ are off due to reverse biases; v_{L}_{ₘ}(t)=Vᵢₙ−2vₚ^{DS}(t)<0; Lₘ has been demagnetized completely; i_{L}_{ₘ}(t)≈0; the induced voltage across N_{d} makes v_{f}^{GS}(t)<0; the channel of SR_{f} is off; the secondary side PWM control circuit switches off the channel of SW and switches on the channel of SR_{w}; i_{L}_{ₒ}(t) flows through Cₒ and the channel of SR_{w} to demagnetize Lₒ; i_{L}_{ₒ}(t) is decreasing linearly with a negative slope

$$\frac{d {i}_{{L}_{o}} ( t )}{d t} = - \frac{{V}_{out}}{{L}_{o}} ; {N}_{p}$$

resembles an open circuit conducting no reflected output current; as well as Lₘ, C₁, and C₂ constitute a series resonance circuit to decrease vₚ^{DS}(t) and slightly increase i_{L}_{ₘ}(t).

During the interval of t₅≦t<t₀, vₚ^{GS}(t) is low; the channels of Q₁ and Q₂ are both off;

$$0 < {v}_{p}^{DS} ( t ) \leq \frac{{V}_{in}}{2} ;$$

both D₁ and D₂ are off due to reverse biases; v_{L}_{ₘ}(t)=Vᵢₙ−2vₚ^{DS}(t)>0; Lₘ has been demagnetized completely; i_{L}_{ₘ}(t)≈0; the induced voltage across N_{d} makes v_{f}^{GS}(t)>0; the channel of SR_{f} is on; the secondary side PWM control circuit switches off the channel of SW and switches on the channel of SR_{w}; i_{L}_{ₒ}(t) flows through Cₒ and the channel of SR_{w} to demagnetize Lₒ; i_{L}_{ₒ}(t) is decreasing linearly with a negative slope

$$\frac{d {i}_{{L}_{o}} ( t )}{d t} = - \frac{{V}_{out}}{{L}_{o}} ; {N}_{p}$$

resembles an open circuit conducting no reflected output current; as well as Lₘ, C₁, and C₂ constitute a series resonance circuit to decrease vₚ^{DS}(t) and slightly increase i_{L}_{ₘ}(t).

Since vₚ^{DS}(t_{0·}⁻)=0 as well as both Q₁ and Q₂ are switched on again at t=t_{0·}to discharge vₚ^{DS}(t_{0·})=0 , the first and the second embodiment of the present invention can properly achieve zero voltage switching of primary side switch transistors to reduce switching losses.

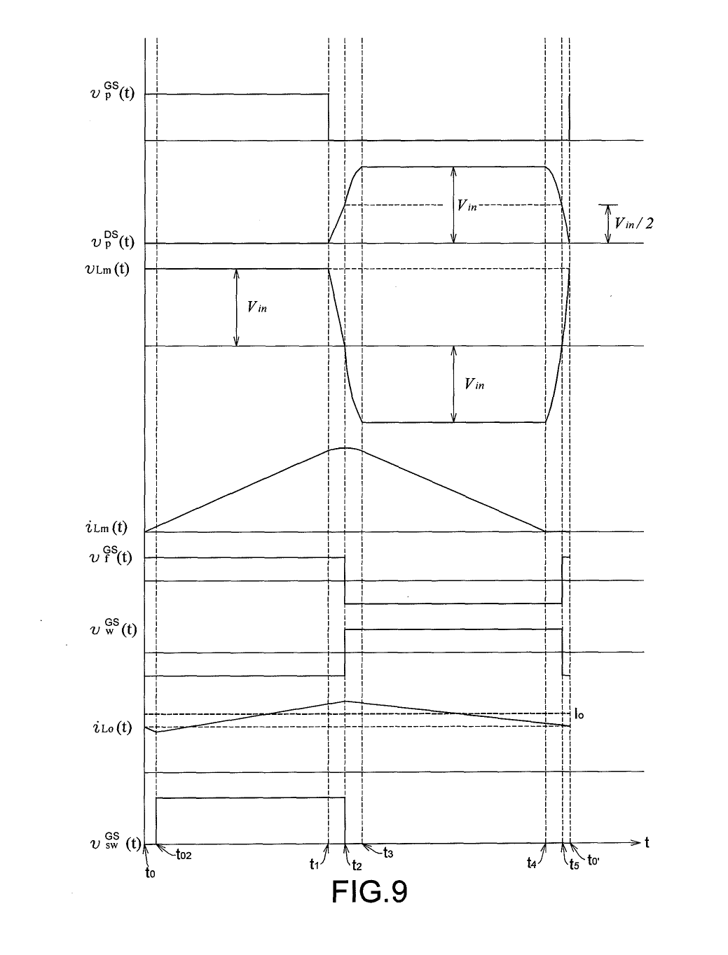

FIG. 9 depicts crucial waveforms of FIG. 8 during a switching period, wherein SR_{w} is driven by N_{d}.

During the interval of t₀≦t<t₁, vₚ^{GS}(t) is high; the channels of Q₁ and Q₂ are both on; vₚ^{DS}(t)=0; both D₁ and D₂ are off due to reverse biases; v_{L}_{ₘ}(t)=Vᵢₙ−2vₚ^{DS}(t)=Vᵢₙ; Lₘ is clamped to Vᵢₙ and magnetized by i_{L}_{ₘ}(t) flowing through the channel of Q₂, Cᵢ, and the channel of Q₁; i_{L}_{ₘ}(t) is increasing linearly with a positive slope

$$\frac{d {i}_{{L}_{m}} ( t )}{d t} = \frac{{V}_{in}}{{L}_{m}} ;$$

the induced voltage across N_{d} makes v_{f}^{GS}(t)>0 and v_{w}^{GS}(t)<0 ; the channel of SR_{f} is on and the channel of SR_{w} is off. According to v_{sw}^{GS}(t) provided by the secondary side PWM control circuit, this interval can be further subdivided into two subintervals:
During the subinterval of t₀≦t<t₀₂, SW switches off its channel to blank the leading edge of the voltage waveform across Nₛ; i_{L}_{ₒ}(t) flows through Cₒ and the body diode of SR_{w} to demagnetize Lₒ; as well as i_{L}_{ₒ}(t) is decreasing linearly with a negative slope

$$\frac{d {i}_{{L}_{o}} ( t )}{d t} = - \frac{{V}_{out}}{{L}_{o}} .$$

During the subinterval of t₀₂≦t<t₁, SW switches on its channel; i_{L}_{ₒ}(t) flows through Cₒ, the channel of SR_{f}, Nₛ, and the channel of SW to magnetize Lₒ; as well as i_{L}_{ₒ}(t) is increasing linearly with a positive slope

$$\frac{d {i}_{{L}_{o}} ( t )}{d t} = \frac{1}{{L}_{o}} ( \frac{{V}_{in}}{n} - {V}_{out} ) .$$

During the interval of t₁≦t<t₂, vₚ^{GS}(t) switches off the channels of Q₁ and Q₂;

$$0 \leq {v}_{p}^{DS} ( t ) < \frac{{V}_{in}}{2} ;$$

both D₁ and D₂ are off due to reverse biases; v_{L}_{ₘ}(t)=Vᵢₙ−2vₚ^{DS}(t)>0; Lₘ is magnetized by i_{L}_{ₘ}(t) flowing through C₂, Cᵢ, and C₁; the induced voltage across N_{d} makes v_{f}^{GS}(t)>0 and v_{w}^{GS}(t)<0; the channel of SR_{f} is on and the channel of SR_{w} is off; the secondary side PWM control circuit switches on the channel of SW; i_{L}_{ₒ}(t) flows through Cₒ, the channel of SR_{f}, Nₛ, and the channel of SW to magnetize Lₒ; both C₁ and C₂ are charged by a reflected output current

$$\frac{{I}_{out}}{n} ;$$

as well as vₚ^{DS}(t) is increasing linearly with a positive slope

$$\frac{d {v}_{p}^{DS} ( t )}{d t} = \frac{{I}_{out}}{{nC}_{1}} .$$

During the interval of t_{2 ≦t<t}₃, vₚ^{GS}(t) is low; the channels of Q₁ and Q₂ are both off;

$$\frac{{V}_{in}}{2} \leq {v}_{p}^{DS} ( t ) < {V}_{in} ;$$

both D₁ and D₂ are off due to reverse biases; v_{Lm}(t)=Vᵢₙ−2vₚ^{DS}(t)<0; Lₘ is demagnetized by i_{L}_{ₘ}(t) flowing through C₂, Cᵢ, and C₁; the induced voltage across N_{d} makes v_{f}^{GS}(t)<0 and v_{w}^{GS}(t)>0; the channel of SR_{f} is off and the channel of SR_{w} is on; the secondary side PWM control circuit switches off the channel of SW; i_{L}_{ₒ}(t) flows through Cₒ and the channel of SR_{w} to demagnetize Lₒ; i_{L}_{ₒ}(t) is decreasing linearly with a negative slope

$$\frac{d {i}_{{L}_{o}} ( t )}{d t} = - \frac{{V}_{out}}{{L}_{o}} ; {N}_{p}$$

resembles an open circuit conducting no reflected output current; as well as Lₘ, C₁ , and C₂ constitute a series resonance circuit to increase vₚ^{DS}(t) and slightly decrease i_{L}_{ₘ}(t).

During the interval of t₃≦t<t₄, vₚ^{GS}(t) is low; the channels of Q₁ and Q₂ are both off; vₚ^{DS}(t)=Vᵢₙ; both D₁ and D₂ are on due to forward biases; v_{L}_{ₘ}(t)=Vᵢₙ−2vₚ^{DS}(t)=−Vᵢₙ; Lₘ is clamped to −Vᵢₙ and demagnetized by i_{L}_{ₘ}(t) flowing through D₂, Cᵢ, and D₁; i_{L}_{ₘ}(t) is decreasing linearly with a negative slope

$$\frac{d {i}_{{L}_{m}} ( t )}{d t} = - \frac{{V}_{in}}{{L}_{m}} ;$$

the induced voltage across N_{d} makes v_{f}^{GS}(t)<0 and v_{w}^{GS}(t)>0; the channel of SR_{f} is off and the channel of SR_{w}is on; the secondary side PWM control circuit switches off the channel of SW; i_{L}_{ₒ}(t) flows through Cₒ and the channel of SR_{w} to demagnetize Lₒ; as well as i_{L}_{ₒ}(t) is decreasing linearly with a negative slope

$$\frac{d {i}_{{L}_{o}} ( t )}{d t} = - \frac{{V}_{out}}{{L}_{o}} .$$

During the interval of t₄≦t<t₅, vₚ^{GS}(t) is low; the channels of Q₁ and Q₂ are both off;

$$\frac{{V}_{in}}{2} < {v}_{p}^{DS} ( t ) \leq {V}_{in} ;$$

both D₁ and D₂ are off due to reverse biases; v_{L}_{ₘ}(t)=Vᵢₙ−2vₚ^{DS}(t)<0; Lₘ has been demagnetized completely; i_{L}_{ₘ}(t)≈0; the induced voltage across N_{d} makes v_{f}^{GS}(t)<0 and v_{w}^{GS}(t)>0; the channel of SR_{f} is off and the channel of SR_{w} is on; the secondary side PWM control circuit switches off the channel of SW; i_{L}_{ₒ}(t) flows through Cₒ and the channel of SR_{w} to demagnetize Lₒ; i_{L}_{ₒ}(t) is decreasing linearly with a negative slope

$$\frac{d {i}_{{L}_{o}} ( t )}{d t} = - \frac{{V}_{out}}{{L}_{o}} ; {N}_{p}$$

resembles an open circuit conducting no reflected output current; as well as Lₘ, C₁, and C₂ constitute a series resonance circuit to decrease vₚ^{DS}(t) and slightly increase i_{L}_{ₘ}(t).

During the interval of t₅≦t<t₀, vₚ^{GS}(t) is low; the channels of Q₁ and Q₂ are both off;

$$0 < {v}_{p}^{DS} ( t ) \leq \frac{{V}_{in}}{2} ;$$

both D₁ and D₂ are off due to reverse biases; v_{L}_{ₘ}(t)=Vᵢₙ−2vₚ^{DS}(t)>0; Lₘ has been demagnetized completely; i_{L}_{ₘ}(t)≈0; the induced voltage across N_{d} makes v_{f}^{GS}(t)>0 and v_{w}^{GS}(t)<0; the channel of SR_{f} is on and the channel of SR_{w} is off; the secondary side PWM control circuit switches off the channel of SW; i_{L}_{ₒ}(t) flows through Cₒ and the body diode of SR_{w} to demagnetize Lₒ; i_{L}_{ₒ}(t) is decreasing linearly with a negative slope

$$\frac{d {i}_{{L}_{o}} ( t )}{d t} = - \frac{{V}_{out}}{{L}_{o}} ; {N}_{p}$$

resembles an open circuit conducting no reflected output current; as well as Lₘ, C₁, and C₂ constitute a series resonance circuit to decrease vₚ^{DS}(t) and slightly increase i_{L}_{ₘ}(t).

Since vₚ^{DS}(t_{0·}⁻⁾=0 as well as both Q₁ and Q₂ are switched on again at t=t_{0·}to discharge vₚ^{DS}(t_{0·})=0, the third and the fourth embodiment of the present invention can properly achieve zero voltage switching of primary side switch transistors to reduce switching losses.

From the foregoing description, it is obvious there exists a causal relationship between secondary side post-regulation of the output voltage and zero voltage switching of primary side switch transistors. During the interval of t₅≦t<t_{0·}, the secondary side controllable switch still remains off so that Nₚ resembles an open circuit conducting no reflected output current as well as Lₘ, C₁, and C₂ continue the series resonance depreciating vₚ^{DS}(t) to nil. This is the central idea of zero-voltage switching greatly differentiating the present invention from prior arts.

It should be noted the location of Nₚ, as shown in FIGS. 4 and 7, is interchangeable with that of Q₁ as long as the driving signal refers to the source of Q₁. In retrospect, the primary side pre-regulation modulates D*ₚᵣᵢ to regulate Vₒᵤₜ, thus different output voltages cannot directly correspond to the same duty ratio of the same primary side switch transistors; the secondary side post-regulation modulates D_{sec} to regulate Vₒᵤₜ, thus different output voltages can directly correspond to different duty ratios of different secondary side controllable switches. Therefore, the secondary side post-regulation, in addition to zero-voltage switching of primary side switch transistors, is more suitable for simultaneously regulating a multitude of different output voltages than the primary side pre-regulation.

While the present invention is susceptible to alternative forms and various modifications, specific examples thereof have been shown in the drawings and described in detail. Not limited to the particular forms disclosed herein, the present invention covers all the alternatives, equivalents, and modifications falling within the scope and spirit of the appended claims.

What is claimed is:

1. A forward converter with secondary side post-regulation and zero voltage switching comprising:
a primary side power loop with an input voltage terminal and a primary ground terminal for receiving an input voltage, wherein an input filter capacitor is connected between said input voltage terminal and said primary ground terminal;
a secondary side power loop with an output voltage terminal and a secondary ground terminal for outputting an output voltage, comprising:
a forward synchronous rectifier transistor with a drain, a source and a gate;
a freewheeling synchronous rectifier transistor with a drain, a source and a gate;
a controllable switch with a first terminal, a second terminal and a control terminal;
a power inductor; and
a filter capacitor; and
a transformer, connected between said primary side and said secondary side, comprising:
a primary side winding with a positive terminal and a negative terminal, connected to said primary side power loop;
a secondary side power winding with a positive terminal and a negative terminal, respectively corresponding to said positive terminal and said negative terminal of said primary side winding, connected to said secondary side power loop; and
a secondary side driving winding with a positive terminal and a negative terminal, respectively corresponding to said positive terminal and said negative terminal of said primary side winding; wherein
said drain of said forward synchronous rectifier transistor is connected to said negative terminal of said secondary side power winding, said source of said forward synchronous rectifier transistor and said source of said freewheeling synchronous rectifier transistor are commonly connected to said secondary ground terminal, said drain of said freewheeling synchronous rectifier transistor is connected to said second terminal of said controllable switch, said first terminal of said controllable switch is connected to said positive terminal of said secondary side power winding;
said power inductor is connected between said drain of said freewheeling synchronous rectifier transistor and said output voltage terminal, and said filter capacitor is connected between said output voltage terminal and said secondary ground terminal;
said gate of said forward synchronous rectifier transistor is connected to said positive terminal of said secondary side driving winding via a forward gate resistor, a forward gate-source resistor is connected between said gate and said source of said forward synchronous rectifier transistor;
said negative terminal of said secondary side driving winding connects to said secondary ground terminal;
said gate of said freewheeling synchronous rectifier transistor and said control terminal of said controllable switch are connected to and controlled by a secondary side pulse width modulation (PWM) control circuit.

2. The forward converter with secondary side post-regulation and zero voltage switching as claimed in claim 1, wherein said primary side power loop is a single transistor switch circuit with a switch transistor, and said switch transistor is driven by a constant duty ratio.

3. The forward converter with secondary side post-regulation and zero voltage switching as claimed in claim 1, wherein said primary side power loop is a dual transistor switch circuit with two switch transistors, and said switch transistors are simultaneously driven by a constant duty ratio.

4. The forward converter with secondary side post-regulation and zero voltage switching as claimed in claim 1, wherein said controllable switch is a magnetic amplifier (MA).

5. A forward converter with secondary side post-regulation and zero voltage switching comprising:
a primary side power loop with an input voltage terminal and an primary ground terminal for receiving an input voltage, wherein an input filter capacitor is connected between said input voltage terminal and said primary ground terminal;
a secondary side power loop with an output voltage terminal and a secondary ground terminal for outputting an output voltage, comprising:
a forward synchronous rectifier transistor with a drain, a source and a gate;
a freewheeling synchronous rectifier transistor with a drain, a source and a gate;
a controllable switch with a first terminal, a second terminal and a control terminal;
a power inductor; and
a filter capacitor; and
a transformer, connected between said primary side and said secondary side, comprising:
a primary side winding, with a positive terminal and a negative terminal, connected to said primary side power loop;
a secondary side power winding, with a positive terminal and a negative terminal respectively corresponding to said positive terminal and said negative terminal of said primary side winding, connected to said secondary side power loop; and
a secondary side driving winding with a positive terminal and a negative terminal respectively corresponding to said positive terminal and said negative terminal of said primary side winding; wherein
said drain of said forward synchronous rectifier transistor connects to said negative terminal of said secondary side power winding, said source of said forward synchronous rectifier transistor and said source of said freewheeling synchronous rectifier transistor are commonly connected to said secondary ground terminal, said drain of said freewheeling synchronous rectifier transistor is connected to said second terminal of said controllable switch, and said first terminal of said controllable switch is connected to said positive terminal of said secondary side power winding;
said power inductor connects between said drain of said freewheeling synchronous rectifier transistor and said output voltage terminal, and said filter capacitor connects between said output voltage terminal and said secondary ground terminal;
said gate of said forward synchronous rectifier transistor is connected to said positive terminal of said secondary side driving winding via a forward gate resistor, a forward gate-source resistor connects between said gate and said source of said forward synchronous rectifier transistor;
said gate of said freewheeling synchronous rectifier transistor is connected to said negative terminal of said secondary side driving winding via a freewheeling gate resistor, a freewheeling gate-source resistor is connected between said gate and said source of said freewheeling synchronous rectifier transistor; and
said control terminal of said controllable switch is connected to and driven by a secondary side PWM control circuit.

6. The forward converter with secondary side post-regulation and zero voltage switching as claimed in claim 5, wherein said primary side power loop is a single transistor switch circuit with a switch transistor, and said switch transistor is driven by a constant duty ratio.

7. The forward converter with secondary side post-regulation and zero voltage switching as claimed in claim 5, wherein said primary side power loop is a dual transistor switch circuit with two switch transistors, and said switch transistors are simultaneously driven by a constant duty ratio.

8. The forward converter with secondary side post-regulation and zero voltage switching as claimed in claim 5, wherein said controllable switch is a magnetic amplifier (MA).
